(19) United States
(12) Patent Application Publication
(10) Pub. No.: US 2022/0101762 A1
(43) Pub. Date: Mar. 31, 2022

(54) SMART FLAGPOLE WITH WIND-DRIVEN FLAG CAPABLE OF ROTATING ON TOP END OF FLAGPOLE

(71) Applicant: Mingguang TIAN, MEIZHOU (CN)

(72) Inventor: Mingguang TIAN, MEIZHOU (CN)

(21) Appl. No.: 17/156,574

(22) Filed: Jan. 23, 2021

(30) Foreign Application Priority Data
Sep. 30, 2020 (CN) 202022205890.3

(51) Int. Cl. G09F 17/00; F04D 29/40; G01W 1/02; H04N 7/18

(52) U.S. Cl. CPC G09F 17/00; F04D 29/403; H04N 5/2252; H04N 7/18; G01W 1/02

(57) ABSTRACT

Provided is a smart flagpole with a wind-driven flag capable of rotating on a top end of the flagpole, which includes a flagpole base, a fixed pole and a rotating pole. The fixed pole is fixedly connected with the flagpole base. The bottom end of the rotating pole is rotatably connected with a connecting tube. The connecting tube is detachably connected with the top end of the fixed pole. A coupling assembly assisting the connection and positioning is arranged between the connecting tube and the fixed pole.

### CROSS-REFERENCE TO RELATED APPLICATIONS

This application claims priority to Chinese Patent Application No. 202022205890.3 with a filing date of Jan. 11, 2021. The content of the aforementioned applications, including any intervening amendments thereto, are incorporated herein by reference.

### TECHNICAL FIELD

The utility model relates to the technical field of flagpoles, and particularly relates to a smart flagpole with a wind-driven flag capable of rotating on the top end of the flagpole.

### BACKGROUND OF THE UTILITY MODEL

Since ancient times, flags have always been a symbol of cohesion and centripetal force of people. At present, peace has become the theme of development of the times. From countries and departments at all levels to primary and secondary schools or various large-scale sports games, the flag-raising and flag-lowering ceremony has become an essential part of crowd activities, and a flagpole is an essential carrier for the flying of the flag. Generally, raising and lowering the flag or keeping the flag at a certain height can be basically completed. However, we can see that without the influence of meteorological conditions such as natural wind, the flag cannot stretch and fly, and the flag rarely stretches and flies especially on a middle and lower portion of the flagpole. When the flag is raised, lowered or located at a set certain height, because of the continuous change of the direction of the natural wind, the awkward situation that the flag is intertwined around the flagpole and cannot stretch and fly often occurs. Under the condition of no wind or breeze, the flag cannot stretch and fly well. If such situations occur during important activities, it is regrettable, and most people share the same feeling and have a vision of change.

Chinese utility model patent CN210828574U discloses an intelligent flagpole rotating windward along with wind direction, which includes a flagpole base and a flagpole body fixed on the flagpole base. The flagpole body includes a fixed flagpole and a rotating flagpole, and the fixed flagpole and the rotating flagpole are connected through two rotating bearings capable of rotating freely. Under the state of natural wind, an upper portion of the flagpole can be pulled to rotate through a acting force of the natural wind on the flag, so that the flag automatically flies windward. However, according to the solution of the utility model, the fixed flagpole and the rotating flagpole are connected together and cannot be detached, and thus need to be remounted for use. Therefore, the traditional flagpole body cannot be used, and the mounting cost is relatively high.

### SUMMARY OF UTILITY MODEL

In order to overcome the disadvantages in the prior art, the utility model provides a smart flagpole with a wind-driven flag capable of rotating on the top end of the flagpole, which can be rapidly mounted on a traditional flagpole body, thereby facilitating the maintenance and replacement and saving the cost.

To achieve the above purpose, the utility model adopts the following technical solutions:

A smart flagpole with a wind-driven flag capable of rotating on the top end of the flagpole includes a flagpole base, a fixed pole and a rotating pole. The fixed pole is fixedly connected with the flagpole base. The bottom end of the rotating pole is rotatably connected with a connecting tube. The connecting tube is detachably connected with the top end of the fixed pole. A coupling assembly assisting the connection and positioning is arranged between the connecting tube and the fixed pole.

Further, the coupling assembly includes a first upper coupler arranged in the connecting tube and a first lower coupler arranged in the fixed pole. The bottom of the first upper coupler is provided with a first connecting shaft. The first connecting shaft is connected with the first lower coupler in a plugging manner.

Further, a second upper coupler is arranged in the rotating pole. The bottom of the second upper coupler is provided with a second connecting shaft. A second lower coupler is arranged in the connecting tube. The second connecting shaft is connected with the second lower coupler through a rotating bearing. The end portion of the second connecting shaft is provided with a connecting gear. A rotating motor is also arranged in the connecting tube. An output shaft of the rotating motor is provided with a driving gear engaged with the connecting gear. The top end of the rotating pole is provided with a wind measuring apparatus. A control box is arranged in the fixed pole. The wind measuring apparatus and the rotating motor are both electrically connected with the control box.

Further, the top of the rotating pole is provided with a transparent hood. A camera is arranged in the transparent hood. The camera is electrically connected with the control box.

Further, a heating member is arranged in the transparent hood. The top of the transparent hood is provided with a hood cover. The hood cover is tightly connected with the transparent hood. Hot air generated by the heating member may not leak and may not influence the wind measuring apparatus on the top of the transparent hood.

Further, a flag rope retracting and winding apparatus is arranged in the top of the rotating pole. One end of a flag rope is connected with the flag rope retracting and winding apparatus, and the other end penetrates through the rotating pole and is connected with a flag hanging pole.

Further, the flag rope retracting and winding apparatus includes a winding drum rotatably connected into the rotating pole, and an elevation motor driving the winding drum to rotate.

Further, the outer wall of the rotating pole is provided with an air outlet corresponding to the flag hanging pole. The bottom end of the fixed pole is provided with an air inlet. An air filter and a fan are successively arranged inside the fixed pole.

Compared with the prior art, the utility model has the following beneficial effects:

(1) In the smart flagpole with the wind-driven flag capable of rotating on the top end of the flagpole in the utility model, the rotating pole is detachably connected with the fixed pole through the connecting tube, and the coupling assembly is used for assisting the positioning, so that the flagpole can be conveniently modified on the existing flagpole and can be rapidly mounted, thereby facilitating the replacement and maintenance, and reducing the user cost; and a novel flagpole can also be directly produced. The detachable connection in various manners and methods is contained.

(2) In the smart flagpole with the wind-driven flag capable of rotating on the top end of the flagpole in the utility model, the top of the rotating pole is provided with the flag rope retracting and winding apparatus, and the flag rope can be retracted and wound into the flagpole when the flag is not raised, so that the flag rope can be prevented from being exposed to the sun and rain, and the service life of the flag rope can be effectively prolonged.

(3) In the smart flagpole with the wind-driven flag capable of rotating on the top end of the flagpole in the utility model, the top end of the rotating pole is provided with the camera which is electrically connected with the control box, so that security protection and monitoring effects can be realized, and after a picture in which the flag is intertwined around the flagpole is received by the camera, a smart control system arranged in the control box can control the rotating pole to rotate in real time, thereby solving the problem that the flag is intertwined around the flagpole. The rotating connection that controls the rotating pole body in various manners and methods is contained.

### DESCRIPTION OF THE DRAWINGS

FIG. 1 is a structural diagram of a smart flagpole with a wind-driven flag capable of rotating on the top end of the flagpole in the utility model.

In the FIGURE: 1, flagpole base; 2, fixed pole; 201, air inlet; 202, first lower coupler; 3, rotating pole; 301, second upper coupler; 3011 second connecting shaft; 3012, connecting gear; 302, air outlet; 4, air filter; 5, fan; 6, control box; 7, connecting tube; 701, first upper coupler; 7011, first connecting shaft; 702, second lower coupler; 703, rotating motor; 7031, driving gear; 8, wind measuring apparatus; 9, transparent hood; 10, camera; 11, heating member; 12, hood cover; 13, flag rope; 14, flag hanging pole; 15, winding drum; and 16, elevation motor.

### DETAILED DESCRIPTION OF PREFERRED EMBODIMENTS

More specific details are illustrated in the following descriptions to fully understand the utility model. However, the utility model can be implemented in numerous other ways different from the descriptions herein. Those skilled in the art can make similar extension without violating the connotation of the utility model. Therefore, the utility model is not limited by the specific embodiments disclosed below.

### Embodiment 1

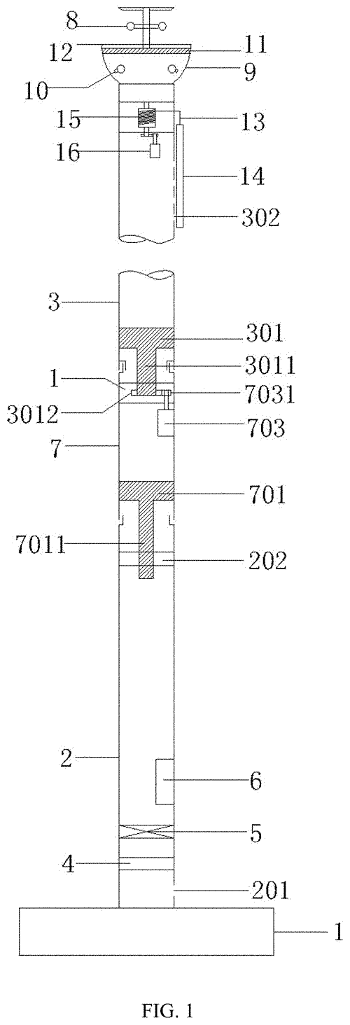

As shown in FIG. 1, a smart flagpole with a wind-driven flag capable of rotating on the top end of the flagpole includes a flagpole base 1, a fixed pole 2 and a rotating pole 3. The fixed pole 2 is fixedly connected to the flagpole base 1. The bottom end of the fixed pole 2 is provided with an air inlet 201. An air filter 4, a fan 5 and a control box 6 are successively arranged above the air inlet 201 inside the fixed pole. The fan 5 is electrically connected with the control box 6.

The bottom end of the rotating pole 3 is rotatably connected with a connecting tube 7. The connecting tube 7 is detachably connected with the top end of the fixed pole 2. A coupling assembly assisting the connection and positioning is arranged between the connecting tube 7 and the fixed pole 2. The coupling assembly includes a first upper coupler 701 arranged in the connecting tube 7 and a first lower coupler 202 arranged in the fixed pole 2. The bottom of the first upper coupler 701 is provided with a first connecting shaft 7011. The first connecting shaft 7011 is connected with the first lower coupler 202 in a plugging manner.

A second upper coupler 301 is arranged in the rotating pole 3, and the bottom of the second upper coupler 301 is provided with a second connecting shaft 3011. A second lower coupler 702 is arranged in the connecting tube 7. The second connecting shaft 3011 is connected with the second lower coupler 702 through a rotating bearing. The end portion of the second connecting shaft 3011 is provided with a connecting gear 3012. A rotating motor 703 is also arranged in the connecting tube 7. An output shaft of the rotating motor 703 is provided with a driving gear 7031 engaged with the connecting gear 3012. The top end of the rotating pole 3 is provided with a wind measuring apparatus 8. The wind measuring apparatus 8 and the rotating motor 703 are both electrically connected with the control box 6.

The top of the rotating pole 3 is provided with a transparent hood 9. A camera 10 is arranged in the transparent hood 9. The camera 10 is electrically connected with the control box 6. A heating member 11 electrically connected with the control box 6 is arranged in the transparent hood 9. The top of the transparent hood 9 is provided with a hood cover 12. The heating member 11 generates heat when the temperature is relatively low to make the temperature in the transparent hood 9 kept above an ice point, so that the transparent hood 9 can be prevented from generating frost that influences the work of the camera 10.

A flag rope retracting and winding apparatus is arranged in the top of the rotating pole 3. One end of a flag rope 13 is connected with the flag rope retracting and winding apparatus, and the other end penetrates through the rotating pole 3 and is connected with a flag hanging pole 14. Specifically, the flag rope retracting and winding apparatus includes a winding drum 15 rotatably connected into the rotating pole 3, and an elevation motor 16 driving the winding drum 15 to rotate. The elevation motor 16 is electrically connected with the control box 6. Of course, the winding drum 15 can be arranged vertically to realize a transverse rope-rolling retracting way and can also be arranged horizontally to realize a longitudinal rope-rolling retracting way. The outer wall of the rotating pole 3 is provided with an air outlet 302 corresponding to the flag hanging pole 14.

The smart flagpole with the wind-driven flag capable of rotating on the top end of the flagpole in the utility model has the following four major functions:

First, a rotating portion of the flagpole is detachable. The coupling assembly 7 can realize rapid mounting and positioning and can be connected with a fixed portion through screws.

Second, the top of the flagpole can receive the flag rope. The winding drum 15 is driven by the elevation motor 16 to rotate to retract and wind the flag rope into the flagpole, thereby realizing the transverse rolling retraction or longitudinal rolling retraction of the rope.

Third, the rotating pole can rotate with the wind, and the flag has an air supplement function. The wind measuring apparatus 8 can measure real-time wind velocity and wind direction parameters and feed back the parameters to the control box 6. Then the control system arranged in the control box 6 calculates a required rotating angle of the rotating pole 3, and the rotating motor 703 is started to drive the rotating pole 3 to rotate, thereby realizing the function of rotation with the wind. Of course, the rotating pole can also rotate naturally under the acting force of the wind that blows the flag. The air supplement function generates an air volume by the fan 4, and then the generated air volume is blown to the flag through the air outlet 302, thereby ensuring that the flag can be kept in a flying state.

Fourth, the camera plays a role in assisting the adjustment. The camera 10 can acquire the state of the flag in real time. If the flag is intertwined, the control system can control the rotating pole 3 to rotate in real time, thereby solving the problem that the flag is intertwined around the flag pole.

The above only describes preferred embodiments of the utility model, and is not used to limit the utility model. Although the utility model has been described in detail with reference to the embodiments, those skilled in the art can modify the technical solutions described in the aforementioned embodiments or make equivalent replacements for some of the technical features, but any modifications, equivalent replacements and improvements made within the spirit and principles of the utility model shall fall within the protection scope of the utility model.

What is claimed is:

1. A smart flagpole with a wind-driven flag capable of rotating on a top end of the flagpole, comprising a flagpole base, a fixed pole and a rotating pole, the fixed pole being fixedly connected with the flagpole base, wherein the bottom end of the rotating pole is rotatably connected with a connecting tube; the connecting tube is detachably connected with the top end of the fixed pole; and a coupling assembly assisting the connection and positioning is arranged between the connecting tube and the fixed pole.

2. The smart flagpole with the wind-driven flag capable of rotating on the top end of the flagpole according to claim 1, wherein the coupling assembly comprises a first upper coupler arranged in the connecting tube and a first lower coupler arranged in the fixed pole; the bottom of the first upper coupler is provided with a first connecting shaft; and the first connecting shaft is connected with the first lower coupler in a plugging manner.

3. The smart flagpole with the wind-driven flag capable of rotating on the top end of the flagpole according to claim 2, wherein a second upper coupler is arranged in the rotating pole; the bottom of the second upper coupler is provided with a second connecting shaft; a second lower coupler is arranged in the connecting tube; the second connecting shaft is connected with the second lower coupler through a rotating bearing; the end portion of the second connecting shaft is provided with a connecting gear; a rotating motor is also arranged in the connecting tube; an output shaft of the rotating motor is provided with a driving gear engaged with the connecting gear; the top end of the rotating pole is provided with a wind measuring apparatus; a control box is arranged in the fixed pole; and the wind measuring apparatus and the rotating motor are both electrically connected with the control box.

4. The smart flagpole with the wind-driven flag capable of rotating on the top end of the flagpole according to claim 3, wherein the top of the rotating pole is provided with a transparent hood; a camera is arranged in the transparent hood; and the camera is electrically connected with the control box.

5. The smart flagpole with the wind-driven flag capable of rotating on the top end of the flagpole according to claim 4, wherein a heating member is arranged in the transparent hood; and the top of the transparent hood is provided with a hood cover.

6. The smart flagpole with the wind-driven flag capable of rotating on the top end of the flagpole according to claim 1, wherein a flag rope retracting and winding apparatus is arranged in the top of the rotating pole; one end of a flag rope is connected with the flag rope retracting and winding apparatus, and the other end penetrates through the rotating pole and is connected with a flag hanging pole.

7. The smart flagpole with the wind-driven flag capable of rotating on the top end of the flagpole according to claim 6, wherein the flag rope retracting and winding apparatus comprises a winding drum rotatably connected into the rotating pole, and an elevation motor driving the winding drum to rotate.

8. The smart flagpole with the wind-driven flag capable of rotating on the top end of the flagpole according to claim 7, wherein the outer wall of the rotating pole is provided with an air outlet corresponding to the flag hanging pole; the bottom end of the fixed pole is provided with an air inlet; and an air filter and a fan are successively arranged inside the fixed pole.
